(19) United States
(12) Patent Application Publication
(10) Pub. No.: US 2007/0156616 A1
(43) Pub. Date: Jul. 5, 2007

(54) APPROXIMATIVE METHODS FOR SEARCHING PARETO OPTIMAL SOLUTIONS IN ELECTRONIC CONFIGURABLE CATALOGS

(75) Inventors: Marc Torrens, Lausanne (CH); Boi Faltings, Preverenges (CH)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: I:FAO AKTIENGESELLSCHAFT, Frankfurt am Main (DE)

(21) Appl. No.: 11/534,902

(22) Filed: Sep. 25, 2006

Related U.S. Application Data
(62) Division of application No. 10/349,502, filed on Jan. 21, 2003, now abandoned.
(60) Provisional application No. 60/350,151, filed on Jan. 18, 2002.

(51) Int. Cl. G06F 15/18

(52) U.S. Cl. 706/19

(57) ABSTRACT

This document describes an invention for searching methods for optimal solutions to configurable electronic catalogs. The document focuses on methods that take into account users' preferences and optimization constraints. These methods use constraint satisfaction techniques.

### CROSS REFERENCE TO RELATED APPLICATION

This application is a divisional of U.S. patent application Ser. No. 10/349,502, which was filed on Jan. 21, 2003, and which claims priority from U.S. provisional application No. 60/350,151 filed on Jan. 18, 2002. Both U.S. patent application Ser. No. 10/349,502 and Provisional Application Ser. No. 60/350,151 are hereby incorporated herein by reference in their entirety.

### BACKGROUND OF THE INVENTION

Products in configurable electronic catalogs are specified by a set of compatible components. Therefore, searching a product amounts to finding a set of compatible components. Usually, there are certain constraints that specify the compatibility among the different components. The process of putting together these compatible components is referred to as a configuration task.

As will be understood by one skilled in the art, there can be several compatible combinations of such components. All the compatible combinations of components are called solutions and they define the “solution space” of a catalog. On the other hand, a user normally has preferences about the product he is looking for. User preferences can also be expressed as constraints among the different components. Constraints modeling a user's preferences are typically less important than configuration constraints. Thus, user preference constraints are referred to as “soft constraints.” Another type of soft constraint for modeling optimization criteria is the price of a particular product.

Weighted CSPs have been shown very suitable for modeling and solving configuration problems with preferences by means of weighted CSPs (See Reference 24). However, there is a need for an improved system and method for identifying optimal solutions to configurable catalogs.

### SUMMARY OF THE INVENTION

This invention comprises improved systems and methods for searching for and identifying optimal solutions to configurable electronic catalogs. These methods preferably take into account users' preferences and optimization constraints, and preferably use constraint satisfaction techniques.

### DETAILED DESCRIPTION OF THE INVENTION

Basically, in configurable electronic catalogs, one can identify the following type of constraints:

Configuration Constraints—Constraints that are related to the configuration task. These constraints are needed to model the compatibility among the different components that have to be composed in any electronic configurable catalog. Because these constraints cannot be violated, they are referred to as “hard constraints.” Configuration constraints guarantee the feasibility and the correctness of a solution.

User Preference Constraints—Constraints related to a user's preferences. The constraints are used to take into consideration the user's specific needs and preferences about the product to be configured.

Optimization Constraints—Constraints that express criteria that can be assumed to be important for every user. Optimization constraints determine the quality or optimality of a solution.

This document describes four methods for searching good solutions to configurable catalogs taking into account the constraints mentioned above. These four methods include: (1) the quantitative approach; (2) the qualitative approach with an approximative method for finding pareto optimal solutions; (3) the qualitative approach with random weighting vectors; and (4) the “learning from past user's experiences” approach. These four methods are summarized below.

1. The Quantitative Approach with Branch and Bound—This method finds solutions that minimize the sum of the valuations for each violated constraint. Prior art searching methods for electronic catalogs try to find the best solution. In contrast, our method tries to find a set of acceptable solutions.

2. The Qualitative Approach with an Approximative Method to Find Pareto Optimal Solutions

3. The Qualitative Approach with Random Weighting Vectors—This is an improvement of the previous method by using randomly generated weighting vectors. These vectors are used for increasing the probability of finding pareto optimal solutions.

4. The “Learning from Past User's Experiences” Approach—This approach takes into consideration solutions already selected by the user in past searching processes. These solutions are used to create, preferably “on-the-fly”, a more accurate weighting vector for the constraints. This new weighting vector is then used to find solutions that are more tailored to the user's preferences, and that, therefore, are more likely to be chosen by the user.

1. Framework and Definitions

As taught in References 12, 13, and 25, which are listed below, Constraint Satisfaction Problems (CSP's) are ubiquitous in configuration applications (See References 11, 17, and 20, listed below), planning applications (See References 5, 10, 14, 18, and 23, listed below), resource allocation (See References 1, 7, 8, and 19, listed below), and timetabling (See References 15 and 16, listed below). A CSP is specified by a set of variables and a set of constraints that apply to these variables. A solution to a CSP is a set of value assignments for all of the variables in a CSP that satisfies all of the CSP's constraints. There can be either many, one, or no solutions (not able to be satisfied) to a given CSP. Formally a CSP is defined as follows:

Definition 2.1 (Constraint Satisfaction Problem (CSP)) A CSP P is a tuple (V, D, C), where:

V={V₁, . . . , Vₙ,} is the set of variables involved in P;

D={D₁, . . . , Dₙ} is the set of domains associated to variables;

C={C₁, . . . , Cₙ} is the set of constraints which must be satisfied for any solution of P.

A constraint C involving a set of variables W={V₁, . . . , Vᵢ)⊂V is denoted by Cv₁ . . . vᵢ. A constraint Cv₁ . . . vᵢ; is a set of relations {R₁, . . . , R₂} on the subset of variables V₁ . . . Vᵢ. The subset of variables W is called the connection of the constraint and denoted by con (Cᵢ). A relation R over a constraint Cv₁, . . . vᵢ, is defined by RεD₁, x . . . x Dᵢ and denotes the tuples that satisfy Ci. The arity of a constraint C is the size of its connection. Unary constraints only affect one variable, and binary constraints are those with a connection value of 2. If the connection of a constraint is higher than 2, the constraint is called n-ary.

Several extensions of classical CSP's have been proposed in order to model and solve problems that cannot be approached using standard CSP's. Classical CSP's, as defined above, assume conditions that are not given in many real-life scenarios. These assumed conditions include, for example, the following: (1) the assumption that the constraints are crisp; (2) the assumption that constraints are always supposed to be known; and (3) the assumption that constraints are equally important. Such assumed conditions are, in fact, not a true representation of a typical user's preferences for electronic catalogs. More particularly, users typically know roughly what they want, but are commonly not able to precisely describe what they prefer.

Some of the main extensions of the classical concept of CSP are “partial CSP” (See Reference 9, listed below), constraint hierarchies (See Reference 4, listed below), “soft CSP” (See Reference 2, listed below), and MAX-CSP (See Reference 3, listed below). Soft CSP can be specified by two general frameworks—one based on semirings and the other based on ordered monoid structures (Valued CSP's) (See Reference 2, listed below). Both frameworks allow us to specify many different types of soft CSPs in a uniform and elegant formalism.

Among other things, this document address weighted CSP's (WCSP's), which are a subclass of valued CSP's. Tuples in constraints of a weighted CSP have an associated cost or valuation. Therefore, weighted CSP's are very useful for modeling optimization problems where the goal is to minimize the sum of the valuations associated to each tuple in the constraints of the problem. The valuation (cost function) for any assignment of a set of variables is the arithmetic sum of the costs of the implied tuples in the constraints. Moreover, a solution to a weighted CSP is an assignment of a valuation to each variable in the CSP such that the CSP's total cost is minimized.

In a more formal way we can define weighted CSPs as follows:

Definition 2.2 A weighted CSP is a CSP with weighted constraints.

Definition 2.3 A weighted constraint C is defined by a cost function p_{c}(a)→[0, ∞] for all tuples a in the constraint C. Thus, a solution to a WCSP is an assignment to all variables such that Σp_{c}(a) is minimized for all the constraints in the problem and all tuples implied in the solution.

Tuples with a cost of zero specify a completely allowed combination. And tuples with a cost of infinity (∞) specify a completely disallowed combination (hard constraint), i.e. a combination that does not properly form a solution.

We now define the concept of valuation for a solution or an assignment of some variables. The valuation of an assignment of variables is the sum of the valuations of all tuples implied in the assignment.
Definition 2.4 (Valuation of a (partial) solution) Assignments in a WCSP can be viewed in terms of costs, qualities or valuations. We denote the valuation of a (partial) solution S with m (n≧m) assignments as V (S) and it is defined as:

$$V ( S ) = {\sum }_{\begin{matrix}∀ {C}_{j} ∈ C \\ ∀ {R}_{i} , ∈ {C}_{j}\end{matrix}}^{⊕} ( {R}_{i} ) , {R}_{i} ⊆ S$$

2. A Domain Application: Travel Configuration Engine

The methods described in this document can be successfully applied to any electronic catalog with preferences, but we focus on the travel domain. In the travel domain, the user has a very large set of possible solutions to choose depending on the airline, schedule, price, cabin class and so on. An itinerary is specified by a set of legs which corresponds to variables (choices) to our model. One could also have a variable for modeling the fare of the solution. The domains of the leg variables are the possible flights for the leg. And the domain for the fare variable are the possible fares that can be applied to the given itinerary. Indeed, we have binary hard constraints in order to ensure that the flight in a leg i arrives before the flight in a leg i+1 takes off. There can also be binary hard constraints between the fare variable and the legs to guarantee that the fare applies to a specific combination of flights.

User's preferences in our model are specified by unary soft constraints. For example, there could be a user preference on the departure time for the first leg. The user could also prefer business class instead of economy class, such a preference is modeled in a unary soft constraint on the fare variable. All kind of preferences about the itinerary can be easily modeled by using soft constraints.

3. First Method Based on Branch and Bound Quantitative Approach

One can address the problem of finding solutions to a WCSP as an optimization problem where the goal is to find solutions that minimize the sum of the violated tuples for each constraint in the solution. As any optimization problem, finding solutions of a WCSP can be done by using a branch and bound algorithm. (See Reference 22, listed below) considers to adapt the solving methods (consistency and forward checking) for classical CSPs to the case of valued CSPs.

Configuration constraints have tuples with the maximum valuation, i.e. hard constraints that cannot be violated. Constraints related to preferences and optimization criteria have tuples with valuations bigger or equal to zero and smaller than the maximum valuation. In addition to that, preferences are normally more important than optimization constraints, therefore valuations for preferences are usually more important than valuations for optimization criteria.

This first method consists of applying branch and bound to WCSP in order to find the n best solutions. The user could then browse through the n solutions and find the one that fits better his needs. This method is different than the standard methods in the sense that it does not try to find the best solution but a set of acceptable solutions.

The solutions to such a weighted CSP are not always appropriate because it assumes a quantitative approach, i.e. solutions that aggregate the preferences to one single criterion. This single criterion amounts to minimize the sum of all the valuations of the tuples which are violated by the solution. The quantitative approach is not always useful because it tries to mix up different constraints at the same level. In real world scenarios, sometimes preferences and soft constraints must be treated independently. As a simple example, let us assume that we have 3 solutions of a problem with 4 weighted constraints. These solutions violate the constraints with the following violations: So←(0, 9, 3, 7); S₁←(9, 3, 3, 1); S₂←(7, 2, 1, 6).

Therefore, the valuations for these solutions are V(S₀)=19; V(S₁)=16; V(S₂)=16. So, the better solutions are S₁, and S₂. However, the solution S₀ does not violate at all the first constraint. Therefore, it would be a good solution in certain real-world applications. A first approach to avoid this problem could be to give more importance to the first constraint. One could imagine a penalty factor for the first constraint in order to penalize more solutions S₁, and S₂. But, this mechanism has a very strong limitation when dealing with many preferences or soft constraints. In such situations, is really hard to put the correct penalty factors because one would deal with side effects.

Very often, the user would like to have solutions that take into consideration preferences separately, namely the qualitative approach. For this reason, we address the problem of finding pareto optimal solutions in weighted CSPs.

4. Second Approximative Method for Pareto Optimal Solutions Qualitative Approach

In this section we describe the notions of pareto optimality related to weighted CSPs. We consider one valuation for each constraint in the problem, thus we can say that a solution has c dimensions where c is the number of all constraints.

A solution to a weighted CSP is called pareto optimal if and only if it is not pareto dominated by any other solution to the problem. A solution is pareto dominated by another one if and only if this solution is worst in all its dimensions.

In a more formal way, we define the following concepts:

Definition 5.1 (A solution S₁ is pareto dominated by a solution S₂) Any solution Sₖ to a problem P has c=|C| dimensions, one dimension for each constraint in the problem, Sₖ←Dₖ=(d_{k,o}, dₖ₋₁, . . . , d_{k, c}, A solution S₁ is pareto dominated by a solution S₂ [symbol] i such that d_{2,i}>d_{1,i}.

Definition 5.2 (Set of pareto optimal solutions) For a problem P with n solutions {S₀, S₁, . . . , Sₙ}, the set of pareto optimal solutions S P is all the solutions that are not dominated by any other. S P={Sᵢ|Sₖ is pareto dominated by Sₖ}.

In a first look, branch and bound algorithms can not be used efficiently for finding the pareto optimal solutions for a weighted CSP. This would amount to explore the whole search space systematically since one cannot decide if a partial assignment is pareto dominated by another one if the assignment is not a complete solution. Look ahead mechanisms with branch and bound are not useful because its computational complexity.

Intuitively, one algorithm could be to compute the best k solutions using branch and bound and find the pareto optimal solutions out of this set of solutions:

1. Step I Find k best solutions to the problem by using standard branch and bound algorithm (previous method).

2. Step 2 Find the pareto optimal solutions of the solutions found in step 1.

Of course, this algorithm does not guarantee to find all pareto optimal solutions. It could also happen that the pareto optimal solutions are not really pareto optimal. However, in many real life cases this algorithm can find an acceptable percentage of pareto optimal solutions.

The number of solutions to be computed using branch and bound would heavily depend on the problem itself and on the quality of the pareto optimal solutions set we are looking for.

This method could be considered as the algorithm that computes the pareto optimal solutions of the best quantitative solutions.

5. Third Approximative Method with an Improvement Using Random Weighting Vectors

An improvement for the method described in the previous section consists on using random weighting vectors for the different constraint valuations. It incorporates an improvement on the generation of the k best solutions (Step 1). In order to increase the quality of the pareto optimal solutions we consider to generate smaller sets of solutions depending on different weightings for the constraints of the WCSP. To generate this different valuations the method uses random vectors of weights. The length of the vectors corresponds to the number of dimensions to the problem. In this way, every dimensions is multiplied by the associated weight.

Let us assume that the catalog is modeled with a set of c constraints:

S={Sₒ, S₁, . . . Sₘ₋₁.}. The method can be summarized as follows:
Step 1 Randomly generate m different vectors of c natural numbers between in a limited range.
Step 2 For each random vector:

Compute the k/m best solutions using branch and bound by taking into consideration the corresponding weighting vector. The component i of the vector multiplies the valuations of the constraint Cᵢ.
Step 3 Find the pareto optimal solutions of the k solutions found in Step 2.
   6. The “Learning from User's Past Experiences” Approach

This approach takes into consideration solutions already taken by the user in past searching processes. These solutions are used to create more accurate weighting vectors for the constraints. By using this vector, the method is able to find more appropriated solutions, i.e. solutions that have more probability to be chosen by the user.

Let us assume that the user has previously chosen m solutions S={Sₒ, S₁, . . . , Sₘ₋₁}. Each solution that has been chosen by the user defines a vector of c dimensions, where c is the number of constraints that were implied in the problem. Thus, we have a set of vectors V={V₀, V₁, . . . , Vₘ₋₁}, each vector corresponds to different set of constraints.

Therefore, these vectors can be used to search solutions that take into consideration the solutions the user has chosen in past experiences. The method is similar to the previous one:
Step 1 For each vector Vᵢ:
   Compute k/m best solutions taking into consideration the corresponding weighting vector Vᵢ. The component j of the vector Vᵢ corresponds to a specific constraint. If this constraint is present in the problem, then its valuations will be multiplied by Vᵢ₍ⱼ₎. If the constraint is not present, its valuations are not affected.
Step 2 Find the pareto optimal solutions of the k solutions found in Step 1.

### CONCLUSION

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

### INCORPORATED REFERENCES

Each of the references listed below is hereby incorporated herein by reference:
Reference 1: Homa Atabakhsh. A Survey of Constraint Based Scheduling Systems Using an Artificial Intelligence Approach. Artificial Intelligence in Engineering, 6(2):58-73, 1991.
Reference 2: Stefano Bistarelli, Helene Fargier, Ugo Montanari, Francesca Rossi, Thomas Schiex, and Gerard Verfaillie. Semiring-based CSPs and Valued CSPs: Basic Properties and Comparison. In M. Jampel, E. Freuder, and M. Maher, editors, Over-Constrained Systems (LNCS 1106), Selected papers from the Workshop on Over-Constrained Systems at CP'95, pages 111-150. Springer, March 1996.
Reference 3: Javier Larrosa Bondia. Algorithms and Heuristics for Total and Partial Constraint Satisfaction. PhD thesis, Institut d'Investigacio en Intelligencia Arftificial, Bellaterra, Catalonia, Spain, 1998.
Reference 4: Alan Borning, Bjorn Freeman-Benson, and Molly Wilson. Constraint Hierarchies. Lisp and Symbolic Computation: An International Journal, 5(3):223-270, September 1992.
Reference 5: Buchanan. Decision Theory, Planning and Constraint Satisfaction. In AAAI Press, editor, Proceedings of the 1994 Spring AAAI Symposium on Decision-Theoretic Planning, page 218, Menlo Park, Calif., US, 1994.
Reference 6: Berthe Y. Choueiry. Abstraction Methods for Resource Allocation. PhD thesis, Swiss Federal Institute of Technology in Lausanne, 1994.
Reference 7: Mark Fox. Constraint Directed Search: A Case Study of Job-Shop Scheduling. Morgan and Kaufmann, Los Altos, Calif., US, 1987.
Reference 8: Mark Fox. Why is Scheduling Difficult? A CSP Perspective. In Proceedings of the 9th ECAI, pages 754-758, Stockholm, Sweden, 1990.
Reference 9: Eugene C. Fruder and Richard J. Wallace. Partial constraint satisfaction. Artificial Intelligence, 58(1):21-70, 1992.
Reference 10: Matthiew L. Ginsberg. A New Algorithm for Generative Planning. In Proceedings of the Fifth International Conference on Principles of Knowledge Representation and Reasoning, pages 186-197, San Francisco, Calif., US, 1996.
Reference 11: Alois Haselbock, Markus Stumptner, and Gerhard Friedrich. COCOS, A Tool for Constraint-Based Dynamic Configuration. In Proceedings of the 10th IEEE Conference on AI Applications, pages 373-380, San Antonio, Tex., US, 1994.
Reference 12: Grzegorz Kondrak and Peter van Beek. A Theoretical Evaluation of Selected Backtracking Algorithms. Artificial Intelligence, 89:365-387, 1997.
Reference 13: Vipin Kumar. Algorithms for Constraint Satisfaction Problems: A Survey. AI Magazine, 13(1):32-14, 1992.
Reference 14: Amy L. Lansky and Andrew G. Philpot. COLLAGE: A Diversified Constraint-Based Planning Architecture. In AAAI Press, editor, Proceedings of the 1993 AAAI Spring Symposium on Foundations of Automatic Planning: The Classical Approach and Beyond, Standford, Calif., US, 1993.
Reference 15: A. Meisels, E. Gudes, and G. Solotorevsky. Combining Rules and Constraints for Employee Timetabling. International Journal Intelligent Systems, 12:419-439, 1997.
Reference 16: F. Menez, P. Barahona, and P. Codognet. An Incremental Constraint Solver Applied to a Timetabling Problem. In Proceedings of the 13th Conference on Expert Systems, pages -, Avignon, France, 1993.
Reference 17: Sanjay Mittal and Felix Freyman. Towards a Generic Model of Configuration Tasks. In Proceedings of the 11th IJCAI, pages 1395-1401, Detroit, Mich., 1989.
Reference 18: Claude Le Pape. Implementation of Resource Constraints in ILOC SCHEDULE: A Library for the Development of Constraint-Based Scheduling Systems. Intelligent Systems Engineering, 3(2):55-66, 1994.
Reference 19: Patrick Prosser and James T. Buchanan. Intelligent Scheduling: past, present, and future. Intelligent Systems Engineering, 3(2):67-78, 1994.
Reference 20: Daniel Sabin and Eugene C. Freuder. Configuration as Composite Constraint Satisfaction. In Proceedings of the Artificial Intelligence and Manufacturing Research Planning Workshop, pages 153-161, 1996.
Reference 21: A. Sathi and Mark S. Fox. Constraint-Directed Negotiation of Resource Allocations. In L. Gasser and M. Huhns, editors, Distributed Artificial Intelligence Volume 11, pages 163-194. Pitman Publishing: London and Morgan Kaufmann, San Mateo, Calif., US, 1989.
Reference 22: Thomas Schiex, Helene Fargier, and Gerard Verfaillie. Valued Constraint Satisfaction Problems: Hard and Easy Problems. In Proceedings of the 1511 IJCAI, pages 631-637, Montreal, Canada, 1995.
Reference 23: Mark Stefik. Planning with Constraints (MOLGEN: Part 1). Artificial Intelligence, 16(2):111-140, 1981.
Reference 24: Marc Torrens, Boi Faltings, and Pearl Pu. Smartclients: Constraint satisfaction as a paradigm for scaleable intelligent information systems. International Journal of Constraints, 7:49-69, 2002.
Reference 25: Edward Tsang. Foundations of Constraint Satisfaction. Academic Press, London, UK, 1993.

What I claim is:

1. (canceled)

2. A method of identifying one or more optimal search results from a set of possible search results, said method comprising the steps of:
receiving one or more constraint variables defining a search, said one or more constraint variables being selectable from a group of variables, wherein each of said one or more constraint variables is assigned a constraint value;
in response to receiving said one or more constraint variables, determining a set of possible search results by crossing each of said one or more constraint variables with said group of variables;
in response to determining said set of possible search results, calculating a valuation for each of said possible search results within said set based on the constraint values assigned to each of said one or more constraint variables;
in response to calculating the valuation for each of said possible search results, identifying a first subset of said search results comprising any one of said possible search results in said set having a valuation less than a maximum value;
in response to identifying said first subset of said search results, identifying a second subset of search results, wherein said second subset of search results includes one or more search results for which all of said constraint values within said search result are less desirable than the corresponding constraint values in each of the remaining search results in said first subset; and
in response to identifying said second subset of search results, identifying a third, pareto optimal subset of search results comprised of the search results included in said first subset and not included in said second subset.

3. The method of claim 2 wherein said constraint value for each of said one or more constraint variables includes a weighted value, and wherein said weighted value for hard constraints is equal to said maximum value and said weighted value for soft constraints is between zero and said maximum value.

4. The method of claim 3 wherein said weighted values for soft constraints having less importance are closer to zero and said weighted values for soft constraints having more importance are closer to said maximum value.

5. The method of claim 3 wherein said weighted values for said soft constraints are randomly assigned.

6. The method of claim 3 wherein said weighted values for said soft constraints are proportionate to the number of times each soft constraint was selected in prior searches by a user.

7. The method of claim 2 further comprising the step of presenting said third pareto optimal subset of search results to a user in response to identifying said third pareto optimal subset of search results.
